(19) United States
(12) Patent Application Publication
(10) Pub. No.: US 2007/0149083 A1
(43) Pub. Date: Jun. 28, 2007

(54) Board formed from a cementitious material and a facer containing a laminate

(76) Inventor: Gaurav Agrawal, Aurora, CO (US)

Correspondence Address: JOHNS MANVILLE, 10100 WEST UTE AVENUE, LITTLETON, CO, 80127, US

(21) Appl. No.: 11/315,842

(22) Filed: Dec. 22, 2005

(51) Int. Cl. B32B 5/26; B32B 13/02

(52) U.S. Cl. 442/386; 442/391

(57) ABSTRACT

A process for producing a board suitable for use as a wallboard or a ceiling panel is provided, comprising: (a) providing a substrate comprising a first facer; (b) applying a slurry comprising a cementitious material on the substrate; and (c) providing a second facer above the slurry, wherein at least one of the first and second facers further comprises a laminate layer.

### BACKGROUND

Boards formed from cementitious material are typically used in the construction of modern buildings, for example, as surfaces for both interior and exterior walls and ceilings and the like. Such boards are typically relatively easy and inexpensive to install, finish, and maintain, and in suitable forms, can be relatively fire resistant.

The boards can be formed from a slurry of the cementitious material, such as a gypsum slurry, for example, by mixing at least one of anhydrous calcium sulfate (CaSO₄) and calcium sulfate hemihydrate (CaSO₄.½H₂O, also known as calcined gypsum) and water. Facers can be provided on either side of the slurry in order to provide structural rigidity to the boards and/or for aesthetic purposes. The cementitious material is allowed to set while being positioned in between the facers.

Conventional facers are generally formed from a relatively porous material such as paper or a fiberglass mat. A problem existing with the use of such conventional facers is that the slurry of the cementitious layer can bleed through the facers in an excessive amount. In some cases, the slurry can bleed through to the outer surface of the facers. Excessive bleed-through of the slurry can detract from the appearance of the resulting product and/or hinder the manufacturing process.

In view of the above, there exists a need for providing a facer for use in a cementitious board, having an improved resistance to bleed-through of a cementitious slurry during the manufacture of the board.

### SUMMARY

According to one aspect, a process for producing a board suitable for use as a wallboard or a ceiling panel is provided, comprising:
(a) providing a substrate comprising a first facer;
(b) applying a slurry comprising a cementitious material on the substrate; and
(c) providing a second facer above the slurry,
wherein at least one of the first and second facers further comprises a laminate layer.

According to a further aspect, a facer suitable for use in a wallboard or a ceiling panel is provided, comprising a glass mat and a laminate layer attached to the glass matt, wherein a plurality of perforations is formed in the laminate layer.

According to another aspect, a board suitable for use as a wallboard or a ceiling panel is provided, comprising:
(a) a layer comprising a cementitious material, and having a first face and a second face; and
(b) first and second facers arranged adjacent to or in contact with the first and second faces of the layer comprising a cementitious material, wherein each facer comprises a layer of a facing material, and at least one facer further comprises a laminate layer.

### BRIEF DESCRIPTION OF THE DRAWINGS

FIG. 1 is a cross-sectional view of a board comprising facers containing laminate layers, according to one exemplary aspect.

FIG. 2 is a cross-sectional view of a board comprising facers containing laminate layers, according to another exemplary aspect.

FIG. 3 is a schematic view of a line for the manufacture of a board, according to a further exemplary aspect.

### DETAILED DESCRIPTION

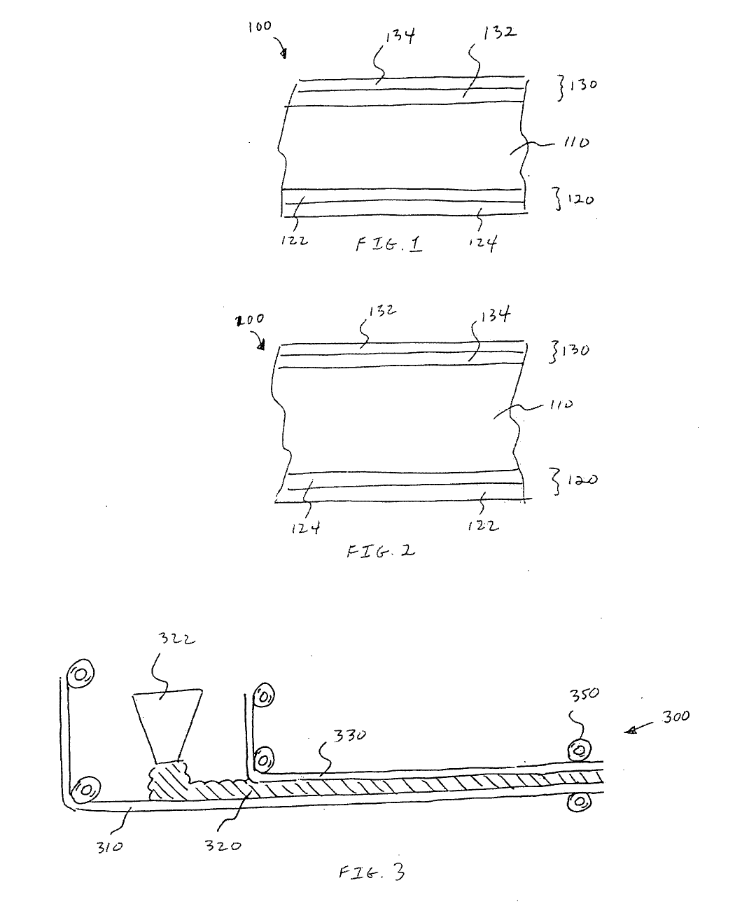

Referring to FIG. 1, a cross-sectional view of an exemplary board 100 is shown. The board comprises a layer 110 comprising a cementitious material. The cementitious material can include any material suitable for use in the production of a board for use as a wallboard, ceiling panel or the like. For example, the cementitious material can be selected from gypsum, Portland cement, a pozzolanic material or a combination thereof. Preferably, the cementitious material can include at least gypsum.

The layer 110 comprising the cementitious material is disposed between first and second facers 120 and 130. The first and second facers 120 and 130 can be directly attached to the cementitious material, or an intermediate layer can be disposed between either of the facers 120 and 130 and the material. The first and second facers 120 and 130 can be attached to the layer 110 by use of an adhesive or binder, and/or the cementitious material itself can be effective to form a bond with the facers 120 and 130.

The cementitious material can include various additives such as, for example, set accelerants, waterproofing agents, defoaming agents, dispersants and/or biocides. The additives can be added at any suitable stage during the manufacturing process of the board 100. For example, cellulose and/or glass fibers can be included in the cementitious material to provide structural reinforcement to the board 100. Optionally, starch can also be added during production of the layer 110 in order to improve the adhesion between the cementitious core and the facers 120 and 130.

Each of the first and second facers 120 and 130 includes a layer of a facing material 122 and 132 such as, for example, a paper material, a non-woven fiberglass mat or a combination thereof. Preferably, the layer of a facing material 122 and 132 includes a non-woven fiberglass mat.

The non-woven fiberglass mat which can be used in at least one facer, and preferably both facers, comprises glass fibers bonded together with a resinous binder. Exemplary fiberglass mats which can be used are disclosed in U.S. Patent Application Publication Nos. 2004/0266303 and 2004/0266304, each published on Dec. 30, 2004, the contents of which are incorporated herein by reference. Any suitable glass fibers can be used including, for example, chopped strand fibers, staple fibers or mixtures thereof. The fiberglass mats can contain various additives such as fillers, pigments, or other inert or active ingredients either throughout the mat or concentrated on a surface. The glass fibers can be bound together with any known water-resistant resinous binder. For example, suitable binders include urea formaldehyde; conventional modified urea formaldehyde; acrylic resins; melamine resins, preferably having a high nitrogen resins such as those disclosed in U.S. Pat. No. 5,840,413; homopolymers or copolymers of polyacrylic acid having a molecular weight of less than 10,000, preferably less than 3,000; crosslinking acrylic copolymer having a glass transition temperature (GTT) of at least about 25 degrees C., crosslinked vinyl chloride acrylate copolymers having a GTT preferably no higher than about 113 degrees C.; and other known flame and water resistant conventional mat binders. Aqueous modified and plasticized urea formaldehyde resin binders may be used and have low cost and acceptably high performance.

At least one of the facers 120 and 130 includes at least one laminate layer. As shown in FIGS. 1 and 2, in an exemplary embodiment, each facer 120 and 130 contains a laminate layer 124 and 134. The laminate layers 124 and 134 can be disposed in any suitable arrangement in the facers 120 and 130. For example, the laminate layers 124 and 134 can constitute the outermost layers of the facers 120 and 130 as shown in FIG. 1, or alternatively, the laminate layers 124 and 134 can constitute the innermost layers of the facers 120 and 130 as shown in FIG. 2. Preferably, the laminate layers 124 and 134 constitute the outermost layers of the facers so as to allow for direct contact between the slurry layer 110 and the facing material of the facers 120 and 130.

The laminate layers 124 and 134 can be formed from any suitable material, for example, a material that has a reduced degree of permeability to the cementitious slurry, in comparison with the facing material. For example, the laminate layers 124 and 134 can be formed from a polymeric material such as polyethylene or a cellulosic material. The laminate layers 124 and 134 can alternatively be formed from a woven or non-woven fibrous mat, which is formed in such a manner so as to have a reduced degree of permeability to the slurry, in comparison with the facing material. The material can optionally include additives to improve the mechanical and/or structural properties thereof including, for example, organic or inorganic particles such as fibrous, rubber or clay particles. The thickness of the laminate layer can depend on the specific application and overall dimensions of the board, and can be, for example, less than about 30 mils, more preferably from about 1 mil to about 4 mils. In an exemplary embodiment, use of the laminate layer can be effective to substantially eliminate the occurrence of bleed-through of the slurry to the surface of the facer employing such laminate layer. The laminate material is attached to the facing material by a lamination process such as adhesive bonding or heat welding.

In an exemplary embodiment, the affixing of the laminate layer to the facing material results in a multi-layered material in which a distinct boundary between the laminate layer and the facing material exists. That is, unlike a coating layer which may bleed into the facing material or otherwise form an indistinct boundary line between the layers, a laminate layer remains distinct from the facing material. Advantageously, employing a laminate layer in place of, for example, a coating can ameliorate problems and/or inefficiencies associated with the use of the coating process and equipment.

The dimensions of the board and the various layers thereof are not particularly limited, and can depend on the specific application of the board. For example, the overall thickness of the board can be from about 0.25 inch to about 1 inch, more preferably from about 0.5 inch to about 0.625 inch. In an exemplary embodiment, the width of the board can be at least about 2 feet, such as about 4 feet. In an exemplary embodiment, the length of the board can be at least about 2 feet, such as from about 8 feet to about 12 feet.

Optionally, at least one of the facers and preferably both facers, has a plurality of perforations formed which extend at least partially into the facer. In an exemplary embodiment, the plurality of perforations at least extends through the laminate layer. The plurality of perforations of the facer is discussed in greater detail in copending Application No. ______, filed on even date herewith, the contents of which are herein incorporated by reference. For example, the plurality of perforations formed in the at least one facer can be effective to reduce or prevent the formation of surface defects such as blisters and bubbles during the drying process of the board. Such defects are conventionally caused, for example, by water vapor escaping from the cementitious layer and being impeded by the facers between which the cementitious layer is arranged. Preferably, the at least one perforated facer has a Gurley permeability of about 60 seconds or less, more preferably from about 20 to about 40.

Use of the plurality of perforations can enable the substantial control and adjustment of the permeability of the facers and board. For example, in an exemplary embodiment, by employing the plurality of perforations to control the permeability, a board can be formed which enables water vapor to vent through the facers during a drying process of the board, while at the same time maintaining sufficient resistance to liquid water penetration through the facer after completion of the board.

Referring to FIG. 3, an exemplary production line 300 for the production of a board suitable for use as a wallboard or ceiling panel is shown. A substrate 310 comprising a first facer is provided, for example, from a substrate roll (not shown). The substrate 310 can consist of only the first facer, or the substrate 310 can include at least one additional layer such as a layer for improving the structural rigidity of the first facer. The substrate 310 can be conveyed in a substantially continuous manner by employing a conveyer belt, a plurality of rollers and/or any other suitable means.

A slurry 320 comprising a cementitious material (such as gypsum slurry) can be provided from a slurry source 322, and the slurry 320 can be applied onto the substrate 310, for example, as the substrate 310 is conveyed underneath the slurry source 322. The flow rate of the slurry 320 to the substrate 310 can depend on various factors, for example, the desired thickness of the resulting core layer of the board, and the contents of the slurry. A second facer 330 can then be provided above the applied slurry 320 and, for example, in contact with the applied slurry 320. At least one of the first and second facers, and preferably both of the first and second facers, comprises a laminate layer. The facers and the slurry can be passed between parallel upper and lower forming plates or rolls 350 in order to generate an integrated and continuous flat strip of unset cementitious material sandwiched between the facers.

The resulting material can be subjected to a setting process, in which the cementitious slurry material present between the facers is allowed to become hardened. The setting process can include conveying the material over a series of continuous moving belts and/or rollers (not shown) for a predetermined period of time, during which time the cementitious core of the material can become hardened. For example, in the case of the use of a gypsum slurry, such slurry at this stage can hydrate back to gypsum (CaSO₄.2H₂O).

Optionally, at least one facer can be conveyed to a perforating device and perforations can be formed in at least one facer, in the manner discussed in copending Application No. ______ filed on even date herewith, the contents of which are herein incorporated by reference. For example, the facers can be conveyed to a perforating device which forms a plurality of perforations which extend at least partially into at least one of the facers. The perforating device can be effective to form a plurality of perforations in both facers. Any suitable mechanism for forming the perforations in the at least one facer can be employed. For example, the perforating device can include at least one rotating cylinder having a plurality of protrusions extending therefrom, wherein the at least one cylinder is mounted to a drive shaft. The protrusions can preferably be sufficiently long to ensure the desired degree of perforation of the facers. For example, the protrusions such as needles can have an average diameter of from about 0.01 inch to about 0.05 inch, and an average length of from about 0.1 inch to about 0.3 inch. The protrusions can be formed from any suitable rigid material such a metallic or non-metallic material. The diameter of the cylinder can be from about 4 inches to about 20 inches.

While the production line 300 is shown and described as operating in a substantially continuous manner, it will be understood that a board can alternatively be produced by employing a batch process.

Once the slurry core has set sufficiently, the material can be cut into shorter lengths or even individual boards of a predetermined length. The resulting material can then be conveyed to a drying device such as an oven or kiln, in which an amount of excess water present in the cementitious layer can be removed therefrom in an accelerated manner. The drying conditions can depend on various factors including, for example, the composition of the slurry material, the dimensions of the board, the line speed, and the degree of perforation (if any) of the perforated facer.

The resulting material can then be removed from the drying device, the ends of the material can be trimmed and the material can be cut into desired sizes to form the perforated board product. For example, the perforated boards can be cut into sheets that are nominally 4 feet wide and 8 to 12 feet or more long. After the drying process, the facers can be treated or otherwise covered with an additional material for aesthetic purposes.

The principles, preferred embodiments, and modes of operation of the present invention have been described in the foregoing specification. The invention which is described herein, however, is not to be construed as being limited to the particular forms disclosed, since these are to be regarded as being illustrative rather than restrictive. Variations and changes can be made by those skilled in the art without departing from the scope of the claims. The inventors do not intend to abandon any disclosed embodiments that are reasonably disclosed but do not appear to be literally claimed below, but rather intend any such embodiments to be included in the claims either literally or as equivalents.

1. A process for producing a board suitable for use as a wallboard or a ceiling panel, comprising:
(a) providing a substrate comprising a first facer;
(b) applying a slurry comprising a cementitious material on the substrate; and
(c) providing a second facer above the slurry,
wherein at least one of the first and second facers further comprises a laminate layer.

2. The process according to claim 1, wherein the cementitious material is selected from the group consisting of gypsum, Portland cement, a pozzolanic material and a combination thereof.

3. The process according to claim 1, wherein each of the first and second facers comprises a facing material comprising a non-woven fiberglass mat.

4. The process according to claim 1, wherein the at least one facer comprising the laminate layer has a Gurley permeability of about 60 seconds or less.

5. The process according to claim 1, wherein the laminate layer is formed from a polymeric material.

6. The process according to claim 1, wherein the laminate layer is arranged as the outermost layer of the facer comprising said laminate layer.

7. The process according to claim 1, wherein each of the first and second facers comprises a laminate layer.

8. The process according to claim 1, wherein a plurality of perforations is disposed in the laminate layer.

9. The process according to claim 1, wherein the laminate layer has a lesser degree of permeability to the slurry than a layer of facing material present in said facer.

10. A facer suitable for use in a wallboard or a ceiling panel, comprising a glass mat and a laminate layer attached to the glass matt, wherein a plurality of perforations is formed in the laminate layer.

11. A board suitable for use as a wallboard or a ceiling panel, comprising:
(a) a layer comprising a cementitious material, and having a first face and a second face; and
(b) first and second facers arranged adjacent to or in contact with the first and second faces of the layer comprising a cementitious material, wherein each facer comprises a layer of a facing material, and at least one facer further comprises a laminate layer.

12. The board according to claim 11, wherein the cementitious material is selected from the group consisting of gypsum, Portland cement, a pozzolanic material and a combination thereof.

13. The board according to claim 11, wherein each layer of facing material comprises a non-woven fiberglass mat.

14. The board according to claim 11, wherein the at least one facer comprising the laminate layer has a Gurley permeability of about 60 seconds or less.

15. The board according to claim 11, wherein the laminate layer is formed from a polymeric material.

16. The board according to claim 11, wherein the laminate layer is arranged as the outermost layer of the facer comprising said laminate layer.

17. The board according to claim 11, wherein each of the first and second facers comprises a laminate layer.

18. The board according to claim 11, wherein a plurality of perforations is disposed in the facer comprising the laminate layer.
